(19) United States
(12) Patent Application Publication
(10) Pub. No.: US 2020/0307785 A1
(43) Pub. Date: Oct. 1, 2020

(54) SYSTEM AND METHOD FOR PROVIDING TOTAL LOGISTIC USING DRONE

(71) Applicant: SEOUL NATIONAL UNIVERSITY R&DB FOUNDATION, Seoul (KR)

(72) Inventors: Ilkyeong MOON, Seoul (KR); Sungwoo KIM, Changwon-si, Gyeongsangnam-do (KR); Minsu KIM, Seoul (KR)

(21) Appl. No.: 16/636,308

(22) PCT Filed: Aug. 1, 2018
(86) PCT No.: PCT/KR2018/008731

§ 371 Date: Feb. 3, 2020

(30) Foreign Application Priority Data
Aug. 2, 2017 (KR) 10-2017-0097975

(51) Int. Cl. B64C 39/02; G05D 1/00; G06Q 10/06

(52) U.S. Cl. CPC B64C 39/024; B64C 2201/128; G06Q 10/0631; G05D 1/0011

(57) ABSTRACT

The present disclosure relates to a total logistics operation system and method using drone, including a delivery information inputter that receives input of delivery information; a delivery model division determiner that extracts, based on the input delivery information, location information of the customer located in an area where drone delivery can be made, speed information of a vehicle and a drone, and location information of the logistics center and the drone station, and that uses the extracted information to determine whether division building of a drone delivery model of using the drone only is possible; and a delivery model builder that, depending on a result of determining whether division of delivery model is possible, builds a delivery model that includes any one of a mixed delivery model for numerous drones and numerous vehicles, the drone delivery model for numerous drones, and a vehicle delivery model for numerous vehicles.

### FIELD

The present invention relates to a total logistics operation system and method using drone, and more particularly, to a total logistics operation system using drone, where drone technology is combined in a logistics system that uses an existing vehicle so as to flexibly respond to new changes in logistics, and a method thereof.

### BACKGROUND

Due to the spread of the Internet and smart phones, the Internet and mobile markets continue to grow. This growth has increased the volume of deliveries rapidly. Thus, it became necessary for delivery companies to deal with the rapidly increasing delivery volume and secure competitiveness through fast delivery. However, in the case of the currently used land delivery, due to limited road conditions and congestion caused by increase of vehicles, it is difficult to secure future competitiveness.

In order to solve these problems, numerous studies are being conducted, which can be divided into two approaches as follows. First approach is to utilize new technology. Studies are being conducted to overcome the limitations on operation time or the external environment while saving labor costs by utilizing unmanned technologies such as drones or autonomous cars. In particular, drone-related technology has achieved dramatic growth since Amazon officially provided a vision for drone delivery in 2013 and limited commercialization is in progress. Drones are cheaper to operate and do not require labor costs, so they can run 24 hours a day. And since delivery objects can be transported by air, additional volume can be processed without affecting the existing logistics system. Further, since it overcomes the fundamental limitations of land transportation-based delivery services such as road congestion, stable and fast delivery services can be expected. However, due to the technical limitations of drones, there are restrictions on the volume or weight of deliveries, and since restrictions on the flight distance and flight time also need to be considered, studies are focusing on improving the flight efficiency and battery performance. In addition, research is underway to overcome drone distance or battery limitations by utilizing additional vehicles or other drone facilities. The second approach is about developing algorithms and systems for efficient logistics management using optimized and mathematical methods. Most transportation companies try to solve the problem by adopting a total management system that considers the customer's demand and cost of transportation, and various models are being actively developed to minimize the cost. However, due to the complex situation in which numerous decisions are made at the same time, the situation is mainly solved through practical experience or know-how rather than through theoretical aspects.

### SUMMARY

Therefore, the present disclosure has been invented to resolve the problems described above.

A purpose of the present disclosure is to provide a total logistics operation system and method using drone, that uses a drone station where drones can be charged and supplied.

Another purpose of the present disclosure is to provide a total logistics operation system and method using drone, that determines whether a drone's delivery model and a vehicle's delivery model can be built separately for a drone station, and that builds a delivery model according to the result.

Another purpose of the present disclosure is to provide a total logistics operation system and method using drone, that visualizes the analysis result of the delivery model that minimizes the time for finishing the delivery.

Another purpose of the present disclosure is to provide a total logistics operation system and method using drone, that visualizes an analysis result of a delivery model that minimizes the time that delivery finishes.

A total logistics operation system using drone according to an embodiment of the present disclosure for achieving the aforementioned purposes, is characterized to include a delivery information inputter that receives input of delivery information that includes location information of customers to receive delivery objects, information of the delivery objects, information of delivery means for delivering the delivery objects, logistics center information and drone station information; a delivery model division determiner that extracts, from the input delivery information, location information of the customer located in an area where drone delivery can be made, speed information of a vehicle and a drone, and location information of the logistics center and the drone station, and that uses the extracted information to determine whether division building of a drone delivery model of using the drone only is possible; and a delivery model builder that, depending on a result of determining whether division of delivery model is possible, builds a delivery model that includes any one of a mixed delivery model for numerous drones and numerous vehicles, the drone delivery model for numerous drones, and a vehicle delivery model for numerous vehicles.

The information of the delivery objects may include at least one of size, volume and weight information of the delivery object.

The information of delivery means may include the speed information of the vehicle and the drone.

The logistics center information may include the location information of the logistics center and number of vehicles in each logistics center.

The drone station information may include the location information of the drone station and number of drones in each drone station.

The delivery model division determiner may determine whether division of delivery model is possible depending on whether the drone of the drone station can deliver all the objects that must be delivered from the corresponding drone station to the customers within a time when the vehicle travels between the corresponding drone station and the logistics center.

The delivery model division determiner may include a customer location determiner that determines the location information of the customer located the farthest from the drone station, of the customers located in the area where drone delivery can be made; a speed determiner that determines the speed information of the vehicle and the drone; a drone station location determiner that determines the location information between the logistics center and the drone station; and a model division determiner that determines whether division of delivery model is possible based on the location information of the customer located the farthest, the speed information of the vehicle and the drone, and the location information between the logistics center and the drone station.

The model division determiner may determine that division of delivery model is possible when the number of drones in the drone station is

$$⌈ \vert N \vert / ⌊ \frac{α \cdot {τ}_{0 , s}}{2 \cdot {τ}_{{o}_{max} , s}} ⌋ ⌉$$

or more, and τ_{s,0}≥2·τ_{s,c}_{ₘₐₓ}/α is satisfied, and may determine that division of delivery model is impossible when the number of drones in the drone station is

$$⌈ \vert N \vert / ⌊ \frac{α \cdot {τ}_{0 , s}}{2 \cdot {τ}_{{o}_{max} , s}} ⌋ ⌉$$

or more, and τ_{s,0}≥2·τ_{s,c}_{ₘₐₓ}/α is not satisfied. Here, N is the number of customers to whom delivery can be made from each drone station of all the customers, α is a speed ratio of the drone and the vehicle (drone speed/vehicle speed), τ_{0,s} is a time it takes for the vehicle to travel between the logistics center and an individual drone station, and τ_{s,Cmax} is a time it takes for the vehicle to travel from the drone station to the customer located the farthest.

The drone station location determiner may determine a distance from the logistics center to each drone station, and the model division determiner may sequentially determine whether division of delivery model is possible starting from the drone station located the farthest to the drone station located the closest from the logistics center.

Further, when it is determined that division of delivery model is impossible for one drone station of numerous drone stations, the model division determiner may determine that division of delivery model is impossible for the drone station from which a distance to the logistics center is shorter than a distance between the one drone station and the logistics center, without a separate determination process.

The delivery model builder may build the drone delivery model for the drone station for which it is determined that division of delivery model is possible, and build the mixed delivery model for the rest of the drone stations.

Further, the total logistics operation system using drone according to an embodiment of the present disclosure may further include a result outputter that visualizes and outputs optimal route information and shortest time information of the vehicle and the drone as a result of the built delivery model.

A total logistics operation method using drone according to an embodiment of the present disclosure may include receiving input of delivery information, determining whether division building of a drone delivery model is possible, and building a delivery model.

The receiving input of delivery information is a step of receiving, by a delivery information inputter, input of delivery information that includes location information of customers to receive delivery objects, information of the delivery objects, information of delivery means for delivering the delivery objects, logistics center information and drone station information.

The determining whether division building of a drone delivery model is possible is a step of extracting, by a delivery model division determiner, from the input delivery information, location information of the customer located in an area where drone delivery can be made, speed information of a vehicle and a drone, and location information of the logistics center and the drone station, and using the extracted information, determining whether division building of a drone delivery model of using the drone only is possible.

The building a delivery model is a step of building, by a delivery model builder, depending on a result of determining whether division building of the delivery model is possible, a delivery model that includes at least one of a mixed delivery model for numerous drones and numerous vehicles, the drone delivery model for numerous drones, and a vehicle delivery model for numerous vehicles.

The determining whether division of delivery model is possible determines whether division of delivery model is possible depending on whether the drone of the drone station can deliver all the objects that must be delivered from the corresponding drone station to the customers within a time when the vehicle travels from the drone station to the logistics center.

The determining whether division of delivery model is possible may include determining the location information of the customer located the farthest from the drone station, of the customers located in the area where drone delivery can be made; determining the speed information of the vehicle and the drone; determining the location information between the logistics center and the drone station; and determining whether division of delivery model is possible based on the location information of the customer located the farthest, the speed information of the vehicle and the drone, and the location information between the logistics center and the drone station.

The determining whether division of delivery model is possible may determine that division of delivery model is possible when the number of drones in the drone station is

$$⌈ \vert N \vert / ⌊ \frac{α \cdot {τ}_{0 , s}}{2 \cdot {τ}_{{o}_{max} , s}} ⌋ ⌉$$

or more, and τ_{s,0}≥2·τ_{s,c}_{ₘₐₓ}/α is satisfied, and determine that division of delivery model is impossible when the number of drones in the drone station is

$$⌈ \vert N \vert / ⌊ \frac{α \cdot {τ}_{0 , s}}{2 \cdot {τ}_{{o}_{max} , s}} ⌋ ⌉$$

or more, and τ_{s,0}≥2·τ_{s,c}_{ₘₐₓ}/α is not satisfied. Here, N is the number of customers to whom delivery can be made from each drone station of all the customers, a is a speed ratio of the drone and the vehicle (drone speed/vehicle speed), τ_{0,s} is a time it takes for the vehicle to travel from the logistics center to an individual drone station, and τ_{s,Cmax} is a time it takes for the vehicle to travel from the drone station to the customer located the farthest.

The determining the location information between the logistics center and the drone station may determine a distance from the logistics center to each drone station, and the determining whether division of delivery model is possible may sequentially determine whether division of delivery model is possible starting from the drone station located the farthest to the drone station located the closest from the logistics center.

The determining whether division of delivery model is possible, when it is determined that division of delivery model is impossible for one drone station of numerous drone stations, may determine that division of delivery model is impossible for the drone station from which a distance to the logistics center is shorter than a distance between the one drone station and the logistics center without a separate determination process.

The building the delivery model may build the drone delivery model for the drone station for which it is determined that division of delivery model is possible, and build the mixed delivery model for the rest of the drone stations.

Further, the total logistics operation method using drone according to an embodiment of the present disclosure may further include after the building the delivery model, visualizing and outputting optimal route information and shortest time information of the vehicle and the drone as a result of the built delivery model.

A total logistics operation system and method using drone, according to the present disclosure, having the configuration described above, uses drones from a drone station that can charge and supply drones, and therefore has an effect of overcoming the limitations of the logistics system using the existing vehicle.

Further, the present disclosure determines whether a drone's delivery model and a vehicle's delivery model can be built separately for a drone station, and then builds a delivery model depending on a result of the determination, and therefore has an effect of building the delivery model more quickly.

Further, the present disclosure creates a realizable scenario for overcoming the limitations of the existing logistics system, and therefore has an effect of making it possible to flexibly respond to the rapidly changing logistics technologies.

Further, the present disclosure visualizes the delivery model for minimizing the time when delivery finishes based on route and time, respectively, and therefore has an effect of enabling a user to easily determine an optimized delivery route and time information.

As such, the present disclosure can combine the recent technologies of drone and drone station with the current logistics system, provide a metaheuristic that derives a reasonable solution within a short period of time to a user's convenience in order to minimize the user's decision making load, and provide a visual analysis result so that even non-experts can easily learn, and therefore the present disclosure can gain competitiveness for preparing for the future logistics revolution.

### BRIEF DESCRIPTION OF THE DRAWINGS

FIG. 1 is a view showing an exemplary delivery environment where a total logistics operation system using drone according to the present disclosure is applied;

FIG. 2 is a configuration view of a total logistics operation system using drone according to an embodiment of the present disclosure;

FIG. 3 is a view for describing an output material where optimal route information is visualized according to the present disclosure;

FIG. 4 is a view for describing an output material where shortest time information is visualized according to the present disclosure;

FIG. 5 is a view for describing a detailed configuration of a delivery model division determiner adopted to a total logistics operation system using drone according to the present disclosure;

FIG. 6 is a flowchart for describing a total logistics operation method using drone according to the present disclosure; and

FIG. 7 is a flowchart for describing in detail a method for determining delivery model division in a total logistics operation method using drone according to the present disclosure.

### DETAILED DESCRIPTION

Various modifications can be made to the present disclosure and the present disclosure may have various embodiments, and thus specific embodiments shall be exemplified in the drawings and described in detail.

However, this is not intended to limit the present disclosure to specific embodiments, and it should be understood that all changes, equivalents, and substitutes included in the spirit and technical scope of the present disclosure are included. In describing the drawings, like reference numerals are used for like components.

When a component is referred to as being “connected” to another component, the component may be directly connected to that other component, but it should be understood that other components may be present in between as well. On the other hand, when a component is referred to as being “directly connected” to another component, it should be understood that there is no other component in between.

The terms used herein are for the purpose of only describing specific embodiments and are not intended to limit the present disclosure. Singular expressions include plural expressions unless the context clearly indicates otherwise. In the present application, it is to be understood that terms such as “include” or “have” are intended to indicate that there is a feature, number, step, operation, component, part, or combination thereof described in the specification, and not to exclude the presence or the possibility of addition of one or more other features, numbers, steps, operations, components, parts, or combinations thereof.

Hereinafter, with reference to the drawings attached, desirable embodiments of the present disclosure will be described in further detail. Hereinafter, like reference numerals are used for like components, and duplicate descriptions of the same components are omitted.

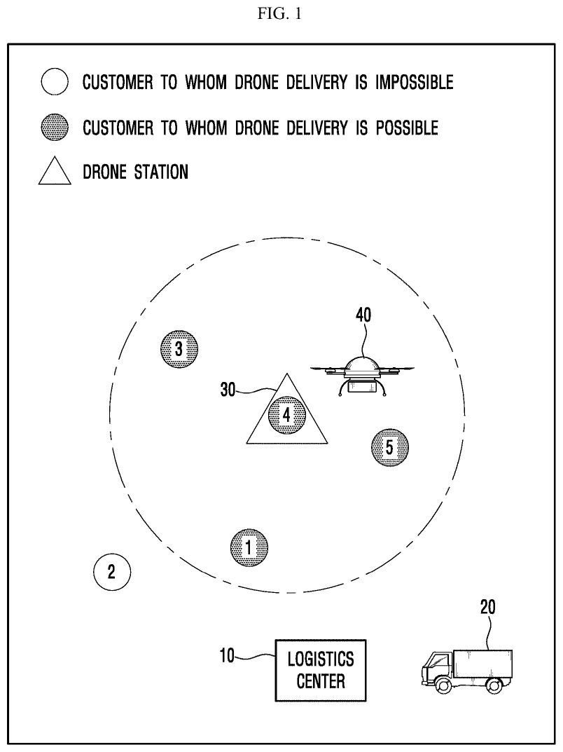

FIG. 1 is a view showing an exemplary delivery environment where a total logistics operation system using drone according to the present disclosure, is applied.

To describe with reference to FIG. 1, the exemplary delivery environment where the total logistics operation system using drone according to the present disclosure, is applied, largely consists of customers \textcircled{1}, \textcircled{2}, \textcircled{3}, \textcircled{4} and \textcircled{5}, a logistics center 10, a vehicle 20, a drone station 30 and a drone 40. Here, in the total logistics operation system using drone 40, the vehicle 20 or the drone 40 visits in order to satisfy delivery demand of individual customers, and generation of demand is based on an actual observation value, and when a scenario is created, a regular distribution and a probability distribution are followed.

A customer is a person who receives a delivery object, and depending on the location of the drone station, the customer may be located in an area where drone delivery can be made or an area where drone delivery cannot be made. The customer located in an area where drone delivery cannot be made may receive the delivery object by the vehicle. That is, in FIG. 1, customers \textcircled{1}, \textcircled{3}, \textcircled{4} and \textcircled{5} are those to whom both vehicle delivery and drone delivery can be made, whereas drone delivery cannot be made to customer \textcircled{2}.

The logistics center 10 is a place where delivery objects to be delivered to the customers and the vehicle 20 for delivering the delivery objects, are stored. In the logistics center 10, the start of delivery is based on a delivery using the vehicle 20. For convenience of description, in FIG. 1, it is assumed that the number of vehicles 20 that can be operated in the logistics center 10 is one.

The vehicle 20 deliveries the delivery objects to the customers by land, and the type of the vehicle 20 may be a truck or a trailer, but there is no limitation thereto. The vehicle 20 can satisfy the delivery demand of numerous customers at once.

The drone station 30 is a place where the delivery objects to be delivered to the customers by the drone, are stored. Further, the drone station 30 is where batteries of the drone 40, are kept. Further, the drone station 30 may receive, from the vehicle 20, the delivery objects to be delivered to the customers located where drone delivery can be made, and then operate the drone 40. For convenience of description, in FIG. 1, it is assumed that the number of drones 40 that can be operated in the drone station 30 is one.

The drone 40 is an airplane, a helicopter, or a quadcopter-shaped aircraft, that flies by the induction of radio waves, without a human on board, and that delivers the delivery objects to the customers located in the area where drone delivery can be made. For safety reasons, it is desirable for the drone 40 to delivery only one delivery object at a time, and delivery objects that are too large or heavy cannot be delivered by the drone 40. Further, the drone 40 has limited travel distance and travel time, and since it uses the sky and not land, it is assumed that it has a faster speed than the vehicle 20. In the present disclosure, it is assumed that the drone 40 delivers the delivery object at twice the speed of the vehicle 20, but there is no limitation thereto. Further, the travel time of the drone 40 includes the time for exchanging batteries.

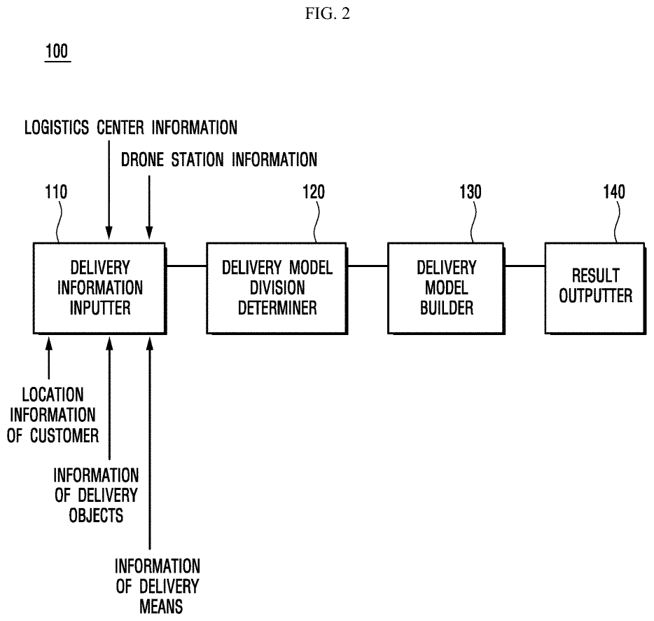

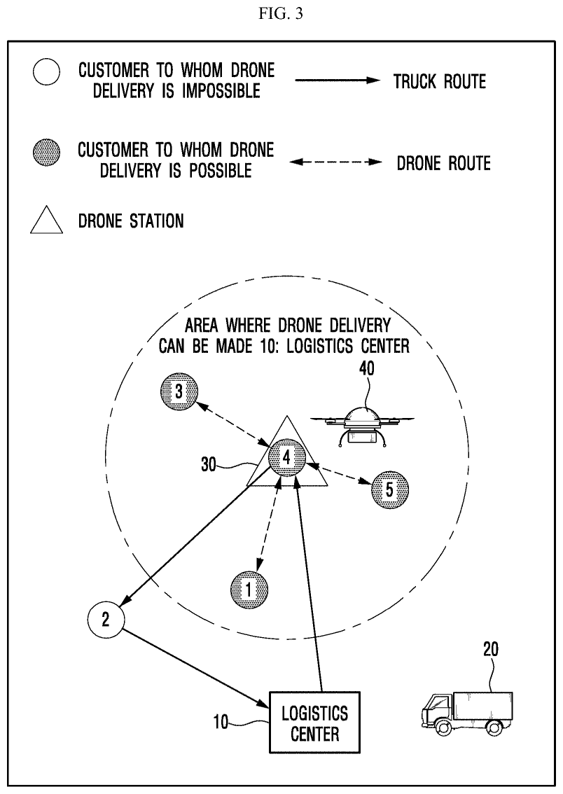

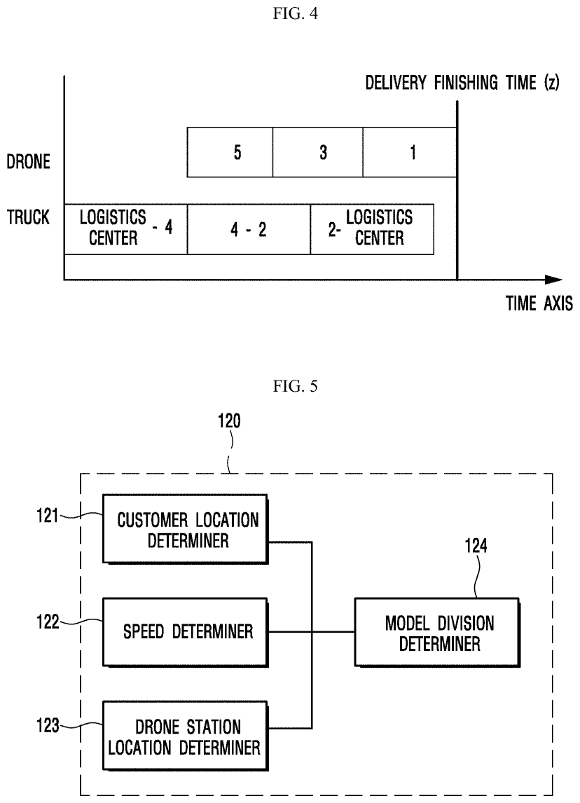

FIG. 2 is a view for describing the configuration of the total logistics operation system using drone according to the present disclosure, FIG. 3 is a view for describing the output material where the optimal route information is visualized according to the present disclosure, and FIG. 4 is a view for describing the output material where the shortest time information is visualized according to the present disclosure.

To describe with reference to FIG. 2, the total logistics operation system using drone 100 according to the present disclosure, largely includes a delivery information inputter 110, a delivery model division determiner 120, a delivery model builder 130 and a result outputter 140.

The delivery information inputter 110 receives input of delivery information that includes location information of customers to receive delivery objects, information of the delivery objects, information of delivery means for delivering the delivery objects, logistics center information and drone station information. Here, the delivery means are the vehicle and the drone.

Here, the information of the delivery objects may include at least one of size, volume and weight information of the delivery object. The information of delivery means may include the speed information of the vehicle and the drone. The logistics center information may include logistics center location information and number of vehicles in each logistics center. The drone station information may include drone station location information and the number of drones in each drone station.

Further, when there is no specific input information input, the delivery information inputter 110 may learn the operation of the drone and the vehicle by creating scenarios. Further, when a certain distribution is input instead of data input as input information, data may be randomly generated according to the corresponding distribution. Here, the certain distribution may be input randomly, or obtained utilizing regression analysis that is based on past data.

The delivery model division determiner 120 determines whether to divide the delivery model as a drone delivery model and a vehicle delivery model for each drone station.

For this purpose, the delivery model division determiner extracts, from the delivery information input into the delivery information inputter, the location information of the customer located in an area where drone delivery can be made, the speed information of the vehicle and the drone, and location information of the logistics center and the drone station.

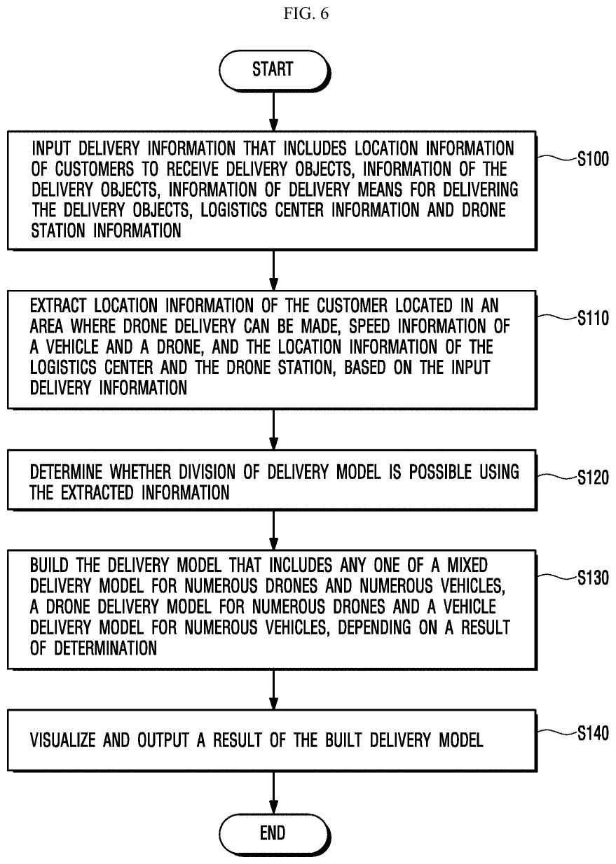

Further, using the extracted information, the delivery model division determiner 120 determines the location of the customer the farthest away from the area where drone delivery can be made from each drone station, the speed of the vehicle and the drone, and the location from the logistics center to each drone station, and based on what is determined, the delivery division determiner 120 determines whether to divide the delivery model as a drone delivery model and a vehicle delivery model. That is, the delivery model division determiner 120 determines whether division building of a drone delivery model using the drone only separate from the vehicle, is possible. This will be described in detail hereinafter with reference to FIG. 5.

Depending on the result of determination, the delivery model builder 130 builds a delivery model that includes any one of a mixed delivery model for numerous drones and numerous vehicles, a drone delivery model for numerous drones, and a vehicle delivery model for numerous vehicles.

Of the numerous drone stations, for an individual drone station for which the delivery model division determiner determined that division of delivery model is possible, the delivery model builder 130 may build a drone delivery model that includes delivery schedule and travel route of numerous drones.

Further, of the numerous drone stations, for the rest of the drone stations except for the drone station for which the delivery model division determiner determined that division is possible, the delivery model builder 130 may build a mixed delivery model that includes delivery schedule and travel route of numerous drones and numerous vehicles.

Here, after first determining whether division of delivery model is possible for the drone station located the farthest from the logistics center of the numerous drone stations, and then determining that division of delivery model is possible for the drone station located the farthest, it is determined whether division of delivery model is possible for the drone station located the next farthest from the logistics center. In this method, it is determined whether division of delivery model is possible for each drone station sequentially, and when it is determined that division of delivery model is impossible for any one of the drone stations, it may be determined that division of delivery model is impossible for the rest of the drone stations as well.

Further, when it is determined that division of delivery model is possible for all the drone stations, a vehicle delivery model that includes delivery schedule and travel route of numerous vehicles, may be built.

As such, in the case of building an individual delivery model for the drone station for which individual model building is possible, and building a mixed delivery model of vehicles and drones for the rest of the drone stations, an optimal route of the drones and the vehicles can be derived faster than when building the delivery model considering the drones of all the drone stations and the vehicles of the logistics center. Here, the delivery model may include a mathematical model such as Equation 1 below that is based on mixed integer programming.

$$\begin{matrix}[ Equation 1 ] & \\ Minimize z \\ subject to & ( 1 ) \\ {\sum }_{{i ∈ {N}_{0}}_{i \neq j}} {x}_{i , j} + {\sum }_{v ∈ V} {y}_{j , v} = 1 ∀ j ∈ N & ( 2 ) \\ {x}_{i , j}^{s} \leq {x}_{i , j} ∀ i ∈ {N}_{0} , ∈ {N}_{1} & ( 3 ) \\ {\sum }_{j ∈ {N}_{2}} {x}_{j , i}^{s} = \{ \begin{matrix}1 , & if i = 0 ; \\ - 1 , & if i = s ; \\ 0 , & otherwise .\end{matrix} ∀ i ∈ {N}_{0} ⋃ \{ c + 1 \} & ( 4 ) \\ z \geq {\sum }_{i ∈ {N}_{0}} {\sum }_{j ∈ {N}_{1}} {τ}_{i , j} \cdot {x}_{i , j}^{s} + {\sum }_{i ∈ D} ( {τ}_{0 , i}^{d} + {τ}_{i , s}^{d} ) \cdot {y}_{i , v} ∀ v ∈ V & ( 5 ) \\ z \geq {\sum }_{i ∈ {N}_{0}} {\sum }_{{j ∈ {N}_{1}}_{i \neq j}} {τ}_{i , j} \cdot {x}_{i , j} & ( 6 ) \\ {\sum }_{j ∈ {N}_{1}} {x}_{0 , j} = 1 & ( 7 ) \\ {\sum }_{i ∈ {N}_{0}} {x}_{i , c + 1} = 1 & ( 8 ) \\ {\sum }_{{i ∈ {N}_{0}}_{i \neq j}} {x}_{i , j} = {\sum }_{{k ∈ {N}_{1}}_{k \neq j}} {x}_{j , k} ∀ j ∈ N & ( 9 ) \\ {u}_{i} - {u}_{j} + 1 \leq ( c + 2 ) \cdot ( 1 - {x}_{i , j} ) ∀ i ∈ N , j ∈ \{ {N}_{1} \text{:} j \neq i \} & ( 10 ) \\ 1 \leq {u}_{i} \leq c + 2 ∀ i ∈ {N}_{1} & ( 11 ) \\ {x}_{i , j} ∈ \{ 0 , 1 \} ∀ i ∈ {N}_{0} , j ∈ \{ {N}_{1} \text{:} j \neq i \} & ( 12 ) \\ {x}_{i , j}^{s} ∈ {ℝ}_{+} & ( 13 ) \\ {y}_{i , v} ∈ \{ 0 , 1 \} ∀ i ∈ D , v ∈ V & ( 14 ) \\ {u}_{i} ∈ {ℝ}_{+} & ( 15 )\end{matrix}$$

Here, set, index, parameter and variable of Equation 1 are as follows.

Z is a random variable made to indicate the greatest time of the service ending time of the vehicle or drone stations,

N is a node set of customers, {1, . . . ,c},

N₀ is a starting node set, {0, . . . ,c},

N₁ is an arrival node set, {1, . . . ,c+1},

V is a set of drones operated in the drone station, {1, . . . ,v},

D is a node set of customers to whom drone delivery can be made, D⊆N,

s is a node index of the drone station,

0 is a starting node index of the logistics center,

c+1 is an arrival node index of the logistics center,

τ_{i,j} is the time it takes for the vehicle to move from node i to node j (∀i∈N0, j∈N1),

τ^{d}_{i,j} is the time it takes for the drone to move from node i to node j (∀i∈N0, j∈N1),

χ_{i,j} is 1 if the vehicle moves from node i to node j, but otherwise 0,

χ^{s}_{i,j} is the variable for tracking the route where the vehicle travels from node i to node j before arriving at the drone station,

y_{i,v} is 1 if drone v delivers to customer node i, but otherwise 0,

z is the time it takes for the vehicle and the drone to finish all deliveries,

uᵢ is a relative location of node i∈N₁ in the vehicle's route.

The first restricting condition of Equation 1 is an objective function, meaning that it minimizes the time it takes for the drone and the vehicle to finish all deliveries and return back to the logistics center. The second restricting condition represents the condition that the vehicle and the drone must visit a customer node only once at most. The third restricting condition is an assumption that the tracking route of the vehicle is the route that the vehicle moved. The fourth restricting condition tracks the route before the vehicle arrives at the drone station. The fifth restricting condition means that an objective value must be greater than the time the drone finishes delivery. The sixth restricting condition means that the objective value must be greater than the time the vehicle finishes delivery. The seventh, the eighth and the ninth restricting conditions are conditions regarding the route of the vehicle. The tenth restricting condition is for eliminating subtour of the vehicle, and the rest of the restricting conditions define general variables.

As illustrated in FIG. 1, Equation 1 mentioned above is an example of a delivery model that includes the delivery schedule and travel route of the drone in one drone station and the vehicle of one logistics center, and by solving the mixed delivery model of the vehicle and the drone such as Equation 1, a solution for the delivery schedule and travel route of the drone and the vehicle can be obtained.

However, the present disclosure is not limited to the case composed of one drone station and one logistics center, and a skilled person in the related art could expand Equation 1 and build a delivery model for the drone of numerous drone stations and the vehicle of numerous logistics center.

However, deriving an optimal solution for the delivery schedule and travel route of the drone and the vehicle by solving the delivery model such as Equation 1 takes more time than separately building the delivery model of the vehicle and the drone and then deriving a solution.

Therefore, it is desirable to determine whether division of delivery model is possible, and then separately build the delivery model for the vehicle and the drone for which division is possible, and then respectively derive the optimal solution for the built delivery model as described above.

In the case of dividing the mathematical model, the delivery model that includes the delivery schedule and travel route of the vehicle can be built with the Restricting Equations (1), (2), (6)-(12), and (15). Here, in the case of (2), variables related to y are not considered, but they can only be considered for customers to whom drone delivery cannot be made. That is, this can be done by simply changing the equation which changed from ∀j∈N to ∀j∈N-D. Further, by assigning the value x derived through the delivery model that includes the delivery schedule and travel route of numerous vehicles to the delivery model for the numerous drones and the numerous vehicles, and then solving the Equation, it is possible to build the delivery model that includes the delivery schedule and the travel route of the numerous drones.

The delivery model builder is based on a mixed integer programming depending on the result of determination by the delivery model division determiner as described above, but by building one or more delivery models, it is possible to obtain the optimal solution that minimizes the delivery time of numerous solutions that satisfy the Equation. However, the method of calculating the delivery time of all the solutions, and then deriving the optimal solution having the smallest delivery time from all the solutions, may take a considerable amount of time depending on the conditions such as the amount of logistics etc. Therefore, in such cases, a heuristic methodology may be applied, which is to derive the solution that minimizes the delivery time the most, as the optimal solution, from the solutions derived within a predetermined time, in order to reduce the time spent in deriving the optimal solution.

The result outputter 140 may visualize the optimal route information and the shortest time information of the vehicle and the drone, which are results of the delivery model built as in FIGS. 3 and 4, and output the same. In more detail, the optimal route information illustrated in FIG. 3 shows that the vehicle starts from the logistics center, then delivers the delivery object to customer \textcircled{4} first, and then finishes the delivery to customer \textcircled{2}, and then comes back to the logistics center. FIG. 3 also shows that the drone, on the other hand, needs only to deliver the delivery objects to customers \textcircled{1}, \textcircled{3} and \textcircled{5}. However, such optimal route information does not include information of when to deliver the delivery objects to the customers. Therefore, time may be determined through the shortest time information such as FIG. 4. The shortest time information illustrated in FIG. 4 shows that the vehicle starts from the logistics center, finishes the delivery to customer \textcircled{4} first, and after finishing the delivery to customer \textcircled{4}, finishes the delivery to customer \textcircled{2}. Thereafter, the vehicle returns back to the logistics center. The drone starts operation after the vehicle delivered the delivery object to customer \textcircled{4} (drone station). The drone delivers the delivery object to customers \textcircled{5}, \textcircled{3} and \textcircled{1}, in that order. Here, the time axis enables one to check the time when the delivery of an object to an individual customer is finished. It also shows the delivery finishing time.

FIG. 5 is a view for describing the detailed configuration of the delivery model division determiner adopted to the total logistics operation system using drone according to the present disclosure.

To describe with reference to FIG. 5, the delivery model division determiner 120 according to the present disclosure extracts, from the input delivery information, the location information of the customer located in the area where drone delivery can be made, the speed information of the vehicle and the drone, and the location information of the logistics center and the drone station, and determines whether division of delivery model is possible using the extracted information.

For this purpose, the delivery model division determiner 120 includes a customer location determiner 121, a speed determiner 122, a drone station location determiner 123 and a model division determiner 124.

For each drone station, the customer location determiner 121 determines the location information of the customer located the farthest from the drone station, of the customers located in the area where drone delivery can be made.

The speed determiner 122 determines the speed information of the vehicle and the drone.

The drone station location determiner 123 determines the location information between the logistics center and each drone station. Here, the location information may be, for example, the travel distance between the logistics center and each drone station.

The model division determiner 124 determines whether division of delivery model is possible.

The model division determiner 124 determines whether division of delivery model is possible based on whether the drone can deliver all the objects that must be delivered from the corresponding drone station to the customers within the time the vehicle travels between the drone station and the logistics center. That is, if the drone can finish all the deliveries for the corresponding station within the time the vehicle travels between the drone station and the logistics center, for the corresponding drone station, it is possible to build a drone delivery model that includes the delivery schedule and travel route of the drone, separate from the vehicle. Further, if the drone cannot finish all the deliveries of the corresponding station within the time the vehicle travels between the drone station and the logistics center, it is not possible to divide the model for the corresponding drone station, and a mixed delivery model of the vehicle and the drone must be built.

In order to determine whether division of delivery model is possible, the model division determiner 124 may determine whether division of delivery model is possible depending on, for example, whether the number of drones each drone station has is

$$⌈ \vert N \vert / ⌊ \frac{α \cdot {τ}_{0 , s}}{2 \cdot {τ}_{{o}_{max} , s}} ⌋ ⌉$$

or more, and whether τ_{s,0}≥2·τ_{s,c}_{ₘₐₓ}/α is satisfied.

Here, N is the number of customers to whom delivery can be made from each drone station of all the customers, α is drone speed/vehicle speed, τ_{0,s} is the time it takes for the vehicle to travel between the logistics center and an individual drone station, and τ_{s,Cmax} is the time for the vehicle to travel from the drone station to the customer located the farthest from the drone station.

τ_{s,0}≥2·τ_{s,c}_{ₘₐₓ}/α means that the drone can deliver the object to the customer located the farthest from the drone station and come back within the time the vehicle travels between the logistics center and the drone station.

Further, the drone station location determiner may determine the distance from the logistics center to the drone station, and the model division determiner may sequentially determine whether division of delivery model is possible starting from the drone station that is located the farthest from the logistics center to the drone station located the closest from the logistics center.

More specifically, the model division determiner first determines whether division of delivery model is possible for the drone station located the farthest from the logistics center of numerous drone stations, and if it is determined that it is possible to divide the delivery model for the drone station located the farthest from the logistics center, then the model division determiner determines whether division of delivery model is possible for the drone station located the next farthest from the logistics center. In this method, the model division determiner sequentially determines whether division of delivery model is possible for the drone stations, and when it is determined that division of delivery model is impossible for any one of the drone stations, it can be determined without a separate determination process that for the rest of the drone stations that are located closer to the logistics center than the drone station for which it was determined that division of delivery model is impossible, division of delivery model is impossible.

FIG. 6 is a flowchart for describing a total logistics operation method using drone according to the present disclosure.

To describe with reference to FIG. 6, the total logistics operation method using drone according to the present disclosure, relates to a method for operating logistics delivery using the total logistics operation system using drone described above, and thus duplicated description will be omitted below.

First, delivery information that includes location information of the customers to receive the delivery objects, information of the delivery objects, information of delivery means for delivering the delivery objects, logistics center information and drone station information, are input (S100).

The delivery information input at step S100 may include at least one of the information of the delivery objects that includes at least one of size, volume and weight information of the delivery object, the information of delivery means that includes the speed information of the vehicle and the drone, the logistics center information that includes the location information of the logistics center and the number of vehicles in each logistics center, and the drone station information that includes the location information of the drone station and the number of drones in each drone station.

Next, from the input delivery information, the location information of the customer located in the area where drone delivery can be made, the speed information of the vehicle and the drone, and the location information of the logistics center and the drone station, are extracted for each drone station (S110).

Next, using the extracted information, it is determined whether division of delivery model is possible that includes the delivery schedule and travel route of numerous drones and numerous vehicles (S120).

Using the extracted information, step S120 determines whether division of delivery model is possible based on whether the drone can deliver all the objects that must be delivered from the corresponding drone station to the customers within the time the vehicle travels between the drone station and the logistics center.

In order to determine whether division of delivery model is possible, the location of the customer located the farthest from the area where drone delivery can be made, the speed of the vehicle and the drone, and the distance information of the logistics center to the drone station, etc. based on the drone station, extracted at step S110, may be used. For example, for each drone station, depending on whether the number of drones in the drone station is

$$⌈ \vert N \vert / ⌊ \frac{α \cdot {τ}_{0 , s}}{2 \cdot {τ}_{{o}_{max} , s}} ⌋ ⌉$$

or more, and whether τ_{s,0}≥2·τ_{s,c}_{ₘₐₓ}/α is satisfied, whether division of delivery model is possible may be determined.

Next, depending on the result of determination, a delivery model is built that includes any one of a mixed delivery model for numerous drones and numerous vehicles, a drone delivery model for numerous drones, and a vehicle delivery model for numerous vehicles (S130).

More specifically, step S130 builds a drone delivery model that includes the delivery schedule and travel route of numerous drones for the drone station for which it is determined that division of delivery model is possible, builds a mixed delivery model that includes the delivery schedule and travel route for numerous drones and numerous vehicles for the drone station for which it is determined that division of delivery model is impossible, and if it is determined that division of delivery model is possible for all the drone stations, S130 builds a drone delivery model for each drone station, and builds a vehicle delivery model, apart from the drone delivery model. In order to minimize the time for deriving the optimal solution, the present disclosure determines whether division of delivery model is possible, and then depending on the result of determination, builds a delivery model that includes one or more of the mixed delivery model for numerous drones and numerous vehicles, the drone delivery model for numerous drones and the vehicle delivery model for numerous vehicles, but if the time it takes to derive the optimal solution that minimizes the delivery time is longer than a predetermined time nevertheless, a heuristic methodology may be applied, which is to derive the solution that minimizes the delivery time the most, as the optimal solution, from the solutions derived within the predetermined time. Lastly, as the result of the delivery model built, the optimal route information and the shortest time information of the vehicle and the drone are visualized and output (S140).

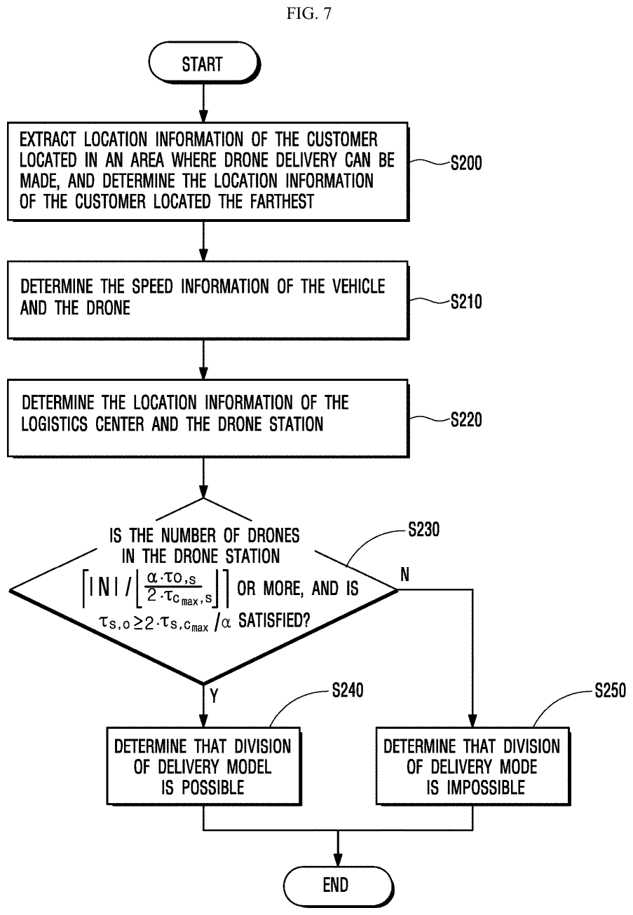

FIG. 7 is a flowchart for describing in detail the method for determining whether division of delivery model is possible in the total logistics operation method using drone according to the present disclosure.

To describe with reference to FIG. 7, the method for determining whether division of delivery model is possible according to the present disclosure first determines the number of drones in each drone station, the number of customers to whom delivery can be made (must be made) from each drone station, and the location information of the customer located the farthest from the drone station of the customers to whom delivery can be made (S200).

Next, the speed information of the vehicle and the drone are extracted, and a speed ratio of the vehicle and the drone is determined (S210).

Next, the location information of the logistics center and the drone station are determined (S220).

Steps S200, S210 and S220 may be performed simultaneously or may be changed in order.

Next, depending on whether the drone of a station can deliver all the objects that must be delivered from the corresponding drone station to the customers within the time the vehicle travels from the drone station to the logistics center, whether division of delivery model is possible is determined (S230).

More specifically, at step S230, for example, depending on whether the number of drones in each drone station is

$$⌈ \vert N \vert / ⌊ \frac{α \cdot {τ}_{0 , s}}{2 \cdot {τ}_{{o}_{max} , s}} ⌋ ⌉$$

or more, and τ_{s,0}≥2·τ_{s,c}_{ₘₐₓ}/α is satisfied, whether division of delivery model is possible is determined.

Here, N is the number of customers to whom the delivery can be made from each drone station of all the customers, a is drone speed/vehicle speed, τ_{0,s} is the time it takes for the vehicle to travel between the logistics center and an individual drone station, and τ_{s,Cmax} is the time for the vehicle to travel from the drone station to the customer who is the farthest from the drone stations.

Next, as a result of comparison at step S230, if the number of drones in the drone station is

$$⌈ \vert N \vert / ⌊ \frac{α \cdot {τ}_{0 , s}}{2 \cdot {τ}_{{o}_{max} , s}} ⌋ ⌉$$

or more, and τ_{s,0}≥2·τ_{s,c}_{ₘₐₓ}/α is satisfied, it is determined that division of delivery model is possible for the corresponding drone station (S240).

Meanwhile, as a result of comparison at step S230, if the number of drones in the drone station is

$$⌈ \vert N \vert / ⌊ \frac{α \cdot {τ}_{0 , s}}{2 \cdot {τ}_{{o}_{max} , s}} ⌋ ⌉$$

or more, but τ_{s,0}≥2·τ_{s,c}_{ₘₐₓ}/α is not satisfied, it is determined that division of delivery model is impossible for the corresponding drone station (S250).

As such, the total logistics operation system and method using drone according to the present disclosure builds a drone station that can charge and supply the drone, which broadens the width of location that can use the drone, thereby overcoming the limitations of the prior art logistics system using vehicle.

Further, the present disclosure determines whether to divide the scheduling and route determining model of numerous drones and vehicles based on the location of the customer located the farthest of the customers to whom drone delivery can be made, the speed ratio of the vehicle and the drone, and the location of the drone station that is the farthest from the logistics center, and provides the user with the decision making information that makes logistics operation easy, and therefore, by creating a feasible scenario for overcoming the limitations of the prior art logistics system, it is possible to flexibly respond to the rapidly changing logistics technology.

Further, the present disclosure visualizes the analysis result of the scheduling and route determining model of numerous drones and numerous vehicles that minimize the time when delivery finishes, based on route and time, respectively, and therefore, it is possible to determine the optimized delivery route and time information.

The functional operations and embodiments relating to the subject matter described in the present specification including the structures disclosed in the present specification and structural equivalents thereof may be implemented in digital electronic circuitry, computer software, firmware or hardware or in combination with one or more of them.

The embodiments of the subject disclosed in the present specification may be implemented as one or more modules regarding a computer program command encoded on a tangible program medium for execution by one or more computer program products, in other words, one or more data processing devices, or for controlling the operations thereof. The tangible program medium may be an electric wave type signal or a computer readable medium. The electric wave type signal is an artificially generated signal such as an electric, optical or electromagnetic signal generated by machinery, for example, for the purpose of encoding information to be transmitted to an appropriate receiving device for execution by a computer. The computer readable medium may be a machine-readable storage device, a machine-readable storage substrate, a memory device, a combination of materials that affect the machine-readable electric wave type signal or a combination of one or more thereof.

A computer program (known as program, software, software application, script or code) may be written in any form of programming language, including compiled or interpreted languages, or a priori or procedural language, and may be deployed in any form, including stand-alone programs or modules, components, subroutines, or other units suitable for use in a computer environment.

The computer program does not necessarily correspond to a file of a file device. The program may be stored in a single file provided in a requested program, in a multiple interactive file (for example, a file that stores a portion of one or more modules, subprograms, or codes), or in a portion of a file that contains other programs or data (for example, one or more scripts being stored in a markup language document).

The computer program can be deployed to run on a single computer or on multiple computers located at one site or distributed across multiple sites and interconnected by a communication network.

Additionally, the logic flows and structural block diagrams described in this patent document describe corresponding acts and/or specific methods supported by the corresponding functions and steps supported by the disclosed structural means, and can also be used to build corresponding software structures, algorithms and their equivalents.

The processes and logic flows described in the present specification may be performed by one or more programmable processors that execute one or more computer programs to perform functions by operating on input data and generating output.

Processors suitable for the execution of computer programs include, for example, both general and special purpose microprocessors and any one or more processors of any kind of digital computer. In general, a processor will receive instructions and data from a read only memory or a random access memory or both.

Core elements of a computer are one or more memory devices for storing instructions and data, and processors for performing the instructions. Further, a computer may be combined or included to be operable to receive data from or transmit data to or perform both operations to and from one or more mass storage devices for storing data, such as for example, magnetic, magneto-optical disks, optical disks, or flash memory.

The foregoing description presents the best mode of the present disclosure, and provides examples to describe the present disclosure and to enable those skilled in the art to make and use the present disclosure. The specification thus written is not intended to limit the present disclosure to the specific terms presented.

In addition, for convenience of description, the foregoing description was made limitedly based on an assumption that one drone makes a delivery to one customer, or one drone is located in the drone station, but it will be easily understood that the present disclosure may be extensively applied such that there are numerous drones in one drone station, and that one drone sequentially makes the delivery to numerous customers.

Therefore, although the present disclosure has been described in detail with reference to the examples described above, those skilled in the art will be able to make modifications, changes, and variations to the examples without departing from the scope of the present disclosure. In short, the present disclosure does not necessarily have to separately include all the functional blocks shown in the drawings or to follow all the orders shown in the drawings in the order shown to achieve the intended effects. Note that even if that is not the case, the present disclosure can still belong to the technical scope of the present disclosure described in the claims.

1. A total logistics operation system using drone, comprising:
a delivery information inputter that receives input of delivery information that includes location information of customers to receive delivery objects, information of the delivery objects, information of delivery means for delivering the delivery objects, logistics center information and drone station information;
a delivery model division determiner that extracts, from the input delivery information, location information of the customer located in an area where drone delivery can be made, speed information of a vehicle and a drone, and location information of the logistics center and the drone station, and that uses the extracted information to determine whether division building of a drone delivery model of using the drone only is possible; and
a delivery model builder that, depending on a result of determining whether division of delivery model is possible, builds a delivery model that includes any one of a mixed delivery model for numerous drones and numerous vehicles, the drone delivery model for numerous drones, and a vehicle delivery model for numerous vehicles.

2. The total logistics operation system using drone according to claim 1,
wherein the information of the delivery objects includes at least one of size, volume and weight information of the delivery object,
the information of delivery means includes the speed information of the vehicle and the drone,
the logistics center information includes the location information of the logistics center and number of vehicles in each logistics center, and
the drone station information includes the location information of the drone station and number of drones in each drone station.

3. The total logistics operation system using drone according to claim 1,
wherein the delivery model division determiner determines whether division of delivery model is possible depending on whether the drone of the drone station can deliver all the objects that must be delivered from the corresponding drone station to the customers within a time when the vehicle travels between the corresponding drone station and the logistics center.

4. The total logistics operation system using drone according to claim 3,
wherein the delivery model division determiner comprises:
a customer location determiner that determines the location information of the customer located the farthest from the drone station, of the customers located in the area where drone delivery can be made;
a speed determiner that determines the speed information of the vehicle and the drone;
a drone station location determiner that determines the location information between the logistics center and the drone station; and
a model division determiner that determines whether division of delivery model is possible based on the location information of the customer located the farthest, the speed information of the vehicle and the drone, and the location information between the logistics center and the drone station.

5. The total logistics operation system using drone according to claim 3,
wherein the model division determiner determines that division of delivery model is possible when the number of drones in the drone station is
$$⌈ \vert N \vert / ⌊ \frac{α \cdot {τ}_{0 , s}}{2 \cdot {τ}_{{o}_{max} , s}} ⌋ ⌉$$
or more, and τ_{s,0}≥2·τ_{s,c}_{ₘₐₓ}/α is satisfied, and determines that division of delivery model is impossible when the number of drones in the drone station is
$$⌈ \vert N \vert / ⌊ \frac{α \cdot {τ}_{0 , s}}{2 \cdot {τ}_{{o}_{max} , s}} ⌋ ⌉$$
or more, and τ_{s,0}≥2·τ_{s,c}_{ₘₐₓ}/α is not satisfied, N being the number of customers to whom delivery can be made from each drone station of all the customers, α being a speed ratio of the drone and the vehicle (drone speed/vehicle speed), τ_{0,s} being a time it takes for the vehicle to travel between the logistics center and an individual drone station, τ_{s,Cmax} being a time it takes for the vehicle to travel from the drone station to the customer located the farthest.

6. The total logistics operation system using drone according to claim 4,
wherein the drone station location determiner determines a distance from the logistics center to each drone station, and the model division determiner sequentially determines whether division of delivery model is possible starting from the drone station located the farthest to the drone station located the closest from the logistics center.

7. The total logistics operation system using drone according to claim 6,
wherein, when it is determined that division of delivery model is impossible for one drone station of numerous drone stations, the model division determiner determines that division of delivery model is impossible for the drone station from which a distance to the logistics center is shorter than a distance between the one drone station and the logistics center, without a separate determination process.

8. The total logistics operation system using drone according to claim 1,
wherein the delivery model builder builds the drone delivery model for the drone station for which it is determined that division of delivery model is possible, and builds the mixed delivery model for the rest of the drone stations.

9. The total logistics operation system using drone according to claim 1,
further comprising a result outputter that visualizes and outputs optimal route information and shortest time information of the vehicle and the drone as a result of the built delivery model.

10. A total logistics operation method using drone, comprising:
receiving, by a delivery information inputter, input of delivery information that includes location information of customers to receive delivery objects, information of the delivery objects, information of delivery means for delivering the delivery objects, logistics center information and drone station information;
extracting, by a delivery model division determiner, from the input delivery information, location information of the customer located in an area where drone delivery can be made, speed information of a vehicle and a drone, and location information of the logistics center and the drone station, and using the extracted information, determining whether division building of a drone delivery model of using the drone only is possible; and
building, by a delivery model builder, depending on a result of determining whether division building of the delivery model is possible, a delivery model that includes at least one of a mixed delivery model for numerous drones and numerous vehicles, the drone delivery model for numerous drones, and a vehicle delivery model for numerous vehicles.

11. The total logistics operation method using drone according to claim 10,
wherein the determining whether division of delivery model is possible determines whether division of delivery model is possible depending on whether the drone of the drone station can deliver all the objects that must be delivered from the corresponding drone station to the customers within a time when the vehicle travels from the drone station to the logistics center.

12. The total logistics operation method using drone according to claim 11,
wherein the determining whether division of delivery model is possible includes:
determining the location information of the customer located the farthest from the drone station, of the customers located in the area where drone delivery can be made;
determining the speed information of the vehicle and the drone;
determining the location information between the logistics center and the drone station; and
determining whether division of delivery model is possible based on the location information of the customer located the farthest, the speed information of the vehicle and the drone, and the location information between the logistics center and the drone station.

13. The total logistics operation method using drone according to claim 11,
wherein the determining whether division of delivery model is possible determines that division of delivery model is possible when the number of drones in the drone station is
$$⌈ \vert N \vert / ⌊ \frac{α \cdot {τ}_{0 , s}}{2 \cdot {τ}_{{o}_{max} , s}} ⌋ ⌉$$
or more, and τ_{s,0}≥2·τ_{s,c}_{ₘₐₓ}/α is satisfied, and determines that division of delivery model is impossible when the number of drones in the drone station is
$$⌈ \vert N \vert / ⌊ \frac{α \cdot {τ}_{0 , s}}{2 \cdot {τ}_{{o}_{max} , s}} ⌋ ⌉$$
or more, and τ_{s,0}≥2·τ_{s,c}_{ₘₐₓ}/α is not satisfied, N being the number of customers to whom delivery can be made from each drone station of all the customers, α being a speed ratio of the drone and the vehicle (drone speed/vehicle speed), τ_{0,s} being a time it takes for the vehicle to travel from the logistics center to an individual drone station, τ_{s,Cmax} being a time it takes for the vehicle to travel from the drone station to the customer located the farthest.

14. The total logistics operation method using drone according to claim 12,
wherein the determining the location information between the logistics center and the drone station determines a distance from the logistics center to each drone station, and
the determining whether division of delivery model is possible sequentially determines whether division of delivery model is possible starting from the drone station located the farthest to the drone station located the closest from the logistics center.

15. The total logistics operation method using drone according to claim 14,
wherein the determining whether division of delivery model is possible, when it is determined that division of delivery model is impossible for one drone station of numerous drone stations, determines that division of delivery model is impossible for the drone station from which a distance to the logistics center is shorter than a distance between the one drone station and the logistics center without a separate determination process.

16. The total logistics operation method using drone according to claim 10,
wherein the building the delivery model builds the drone delivery model for the drone station for which it is determined that division of delivery model is possible, and builds the mixed delivery model for the rest of the drone stations.

17. The total logistics operation method using drone according to claim 10,
further comprising, after the building the delivery model, visualizing and outputting optimal route information and shortest time information of the vehicle and the drone as a result of the built delivery model.
